(19) United States
(12) Patent Application Publication
(10) Pub. No.: US 2024/0246239 A1
(43) Pub. Date: Jul. 25, 2024

(54) MULTI-OBJECT PICKING

(71) Applicant: UNIVERSITY OF SOUTH FLORIDA, Tampa, FL (US)

(72) Inventors: Yu Sun, Tampa, FL (US); Zihe Ye, Tampa, FL (US)

(21) Appl. No.: 18/419,474

(22) Filed: Jan. 22, 2024

Related U.S. Application Data
(60) Provisional application No. 63/480,693, filed on Jan. 20, 2023.

(51) Int. Cl. B25J 9/16; B25J 13/08; G06T 7/70

(52) U.S. Cl. CPC B25J 9/1697; B25J 9/161; B25J 9/1666; B25J 13/08; G06T 7/70; G06T 2207/10024; G06T 2207/20081; G06T 2207/20084; G06T 2207/20092

(57) ABSTRACT

Methods and systems are disclosed for efficient and accurate planning of multi-object robotic grasping operations. Such methods and systems allow for implementation of the concept of “only-pick-once”, in which multiple objects are picked by a robotic grasping mechanism according to a grasping plan. A picking plan for a robotic picking arm may be generated according to a desired picking characteristic (e.g., a number of objects per grasp, a goal of minimizing grasping actions, etc.). Sensor data indicative of a work environment may be used to generate a graph relating objects of interest. The objects may be clustered according to various attributes or connections, such as whether a group of objects is within the maximum grasping area of the robotic arm or collision avoidance. The clusters may be ranked, then a picking plan determined for picking clusters by ranking.

### CROSS-REFERENCE TO RELATED APPLICATION(S)

This application claims the benefit of U.S. Provisional Patent Application Ser. No. 63/480,693, filed Jan. 20, 2023.

### STATEMENT REGARDING FEDERALLY SPONSORED RESEARCH

N/A

### BACKGROUND

In many industries (such as manufacturing, transportation, logistics, agriculture, packaging, retail, etc.) a common, repetitive task is picking a specified number of objects from an unorganized or random group or pile of objects, such as from a bin, container, manufacturing line, conveyance belt, etc. When conducted by humans, these tasks are often made more efficient through intelligently efficient movements. For example, in warehouses, workers might perform batch picking (also called multi-order picking) to improve efficiency. That is, picking several of the same objects from a bin at once for multiple orders. For instance, a worker could be instructed that four boxes of toothpaste or three jars of a cosmetic product are needed from a bin or shelf for packing in an order, and so the working will pick all four boxes or all three jars at once. Similarly, in manufacturing, when a task involves attaching a given number of components, workers may grab several of the components (e.g., several nuts or bolts) by only picking once (OPO) and then putting them on one by one. During food prep, multiple slices of a fruit from a cutting board or bowl may be grabbed at once and then dropped into a dessert pan or put onto a plate.

While human workers may decide to perform a multi-object OPO task without much thought, robotic systems do not have the same intuition and planning. For example, if a robotic system is designed to pick up only one item and drop it into a bin in 3 seconds, to pick up two identical items, the robot would need to pick two times, which is 6 seconds. The programming and mechanical abilities of existing robotic systems do not allow for them to dynamically decide to pick more than one object at once or decide if doing so makes sense. In contrast, a human worker can get the same two items by OPO and needs only 3 seconds and probably wouldn't pause to think about doing this at all. When robotic systems are designed to allow for multi-object loading systems, they sacrifice the ability to specify how many or which objects will be grasped, or how many grasping attempts would be needed to load a specified number of objects. For example, robotic systems employing scoops, arms, and similar mechanisms do not have the dexterity necessary for selective picking of objects from a random bin or pile. Thus, at present, human workers remain much faster and much more precise than robots for a variety of tasks.

Efficient and reliable robot picking systems are in urgent demand to relieve recent labor shortage issues. Numerous robot-picking systems have been developed for bin-picking, mainly applying single-object picking (SOP) strategies since the main research and development focus has been on the difficult task of actually recognizing and grasping an object at all. Thus, research and existing systems so far have not developed ways to solve the single picking only limitation, or otherwise how to intelligently pick specified multiples of objects.

### SUMMARY

The following presents a simplified summary of one or more aspects of the present disclosure, to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In some aspects, the present disclosure can provide a method for generating a picking plan for a robotic picking arm. An input or setting comprising a desired picking characteristic may be obtained (e.g., stored, received, determined from other input, etc.). Sensor data (e.g., an image or other output of cameras or other sensors, or a simulation of sensor data) of a work environment containing a plurality of objects may be processed. A graph may be generated based on the image of the work environment. A plurality of connections on the graph may be identified based on a plurality of relative locations, positions, and/or poses corresponding to each of the plurality of objects. One or more clusters may be determined based upon the plurality of connections and/or other characteristics of the objects or clusters. A rank may then be determined corresponding to each of the one or more clusters, using a ranking algorithm. A picking plan comprising at least one grasping pose associated with each of the one or more clusters may be generated. Finally, the picking plan may be outputted.

In further aspects, the present disclosure can provide a system for picking objects. The system can include a sensor, a robotic device, a processor, and a memory. The robotic device can include a multi-axis arm and a set of paddles or other grasping mechanism. The processor may be electrically coupled to the sensor and the robotic arm device. The processor may be configured to execute instructions stored in the memory (e.g., software). The instructions may cause the processor to determine a desired picking characteristic. Sensor data of a work environment containing a plurality of objects may be processed. A graph based on the sensor data of the work environment may be generated. A plurality of connections on the graph may be identified based on a plurality of relative locations, positions, or poses corresponding to each of the plurality of objects. A plurality of clusters from the plurality of connections may be extracted. A plurality of ranks corresponding to each of the plurality of clusters may be determined using a ranking algorithm. A picking plan may be generated, wherein the picking plan may include a plurality of grasping poses associated with each of the plurality of ranks. Finally, the picking plan may be outputted to move the robotic device.

In further aspects, the present disclosure can provide a system for picking objects. The system can include a sensor, a robot device, a process, and a memory. The robotic device can include a multi-axis arm and a set of paddles or other grasping mechanism. The processor may be electrically coupled to the sensor and the robotic arm device. The processor may be configured to execute instructions stored in the memory, which cause the processor to determine a desired grasping characteristic and receive an output of the sensor and determine a grasping plan to achieve the desired characteristic for a given workspace sensed by the sensor. A plurality of movement instructions may be sent to a plurality of motors of the multi-axis arm. The plurality of movement instructions may cause the robotic device to pick a plurality of objects in one grasping motion using the paddles. The grasping motion may be determined in accordance with the grasping plan and the plurality of objects may be determined in accordance with the desired grasping characteristic.

These and other aspects of the disclosure will become more fully understood upon a review of the drawings and the detailed description, which follows. Other aspects, features, and embodiments of the present disclosure will become apparent to those skilled in the art, upon reviewing the following description of specific, example embodiments of the present disclosure in conjunction with the accompanying figures. While features of the present disclosure may be discussed relative to certain embodiments and figures below, all embodiments of the present disclosure can include one or more of the advantageous features discussed herein. In other words, while one or more embodiments may be discussed as having certain advantageous features, one or more of such features may also be used in accordance with the various embodiments of the disclosure discussed herein. Similarly, while example embodiments may be discussed below as devices, systems, or methods embodiments it should be understood that such example embodiments can be implemented in various devices, systems, and methods.

### BRIEF DESCRIPTION OF THE DRAWINGS

FIG. 1 is a flow diagram illustrating an example process for generating a picking plan according to some embodiments.

FIG. 2 is a perspective drawing illustrating an example robotic system for picking objects according to some embodiments.

FIG. 3 illustrates four example scenes of batch picking for four shapes.

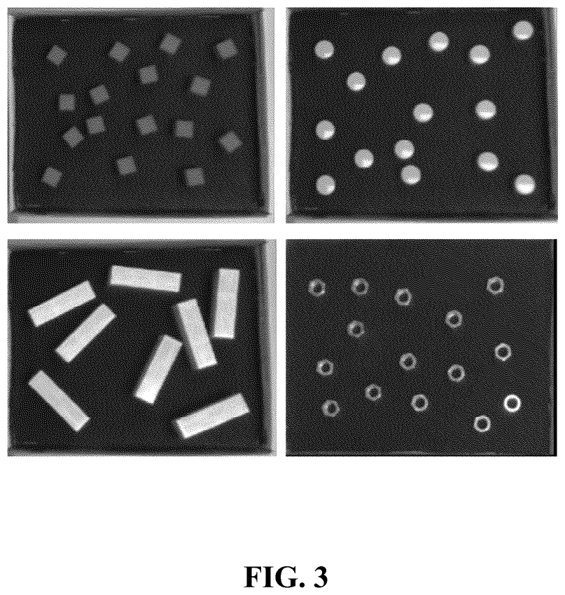

FIG. 4 is a simulation diagram of a robotic system according to some embodiments.

FIG. 5 illustrates a flow diagram of an only-pick-once system according to some embodiments.

FIG. 6 illustrates an example neighbor graph generation for cubes.

FIG. 7 illustrates two example neighbor graphs for cubes and cylinders.

FIG. 8 illustrates three example cluster orientations according to some embodiments.

FIG. 9 illustrates two example cluster metric calculations according to some embodiments.

FIG. 10 illustrates an example picking pose sampling procedure according to some embodiments.

FIG. 11 illustrates four collision checking diagrams according to some embodiments.

FIG. 12 is a flow diagram of an example multi-object picking predictor model architecture according to some embodiments.

FIG. 13 illustrates two example diagrams for edge threshold selection on a cube and a cylinder.

FIG. 14 is an example SRNC curve illustrating the overall success rate according to some embodiments.

FIG. 15 is a diagram that illustrates four example shapes being used in an example simulation according to some embodiments.

FIG. 16 is a diagram that illustrates an example picking setup according to some embodiments.

FIG. 17 illustrates four confusion matrices according to some embodiments.

### DETAILED DESCRIPTION

The detailed description set forth below in connection with the appended drawings is intended as a description of various configurations and is not intended to represent the only configurations in which the subject matter described herein may be practiced. The detailed description includes specific details to provide a thorough understanding of various embodiments of the present disclosure. However, it will be apparent to those skilled in the art that the various features, concepts and embodiments described herein may be implemented and practiced without these specific details. In some instances, well-known structures and components are shown in block diagram form to avoid obscuring such concepts.

The advantages gained by using embodiments of the present disclosure can be achieved in several ways: in some embodiments, a technique or method may be implemented through software that can be installed for operating on an existing, specialized system (e.g., having a sensor and robotic arm); in other embodiments, a system may be implemented specifically to perform the techniques and methods described herein. Moreover, such software and systems implementations, as well as other embodiments, can be used in a variety of environments. For example, static bins, containers, or piles of objects can be presented to a system that views (e.g., via a camera or other sensor) and picks the objects from above. In other embodiments, shelves or other stacked/vertical storage of objects may be presented to a system that views and picks the objects from a lateral position. And, in other embodiments, moving bins or conveyor belts may pass in front of a system that picks from a “changing” landscape of objects in real time.

### Method and Techniques

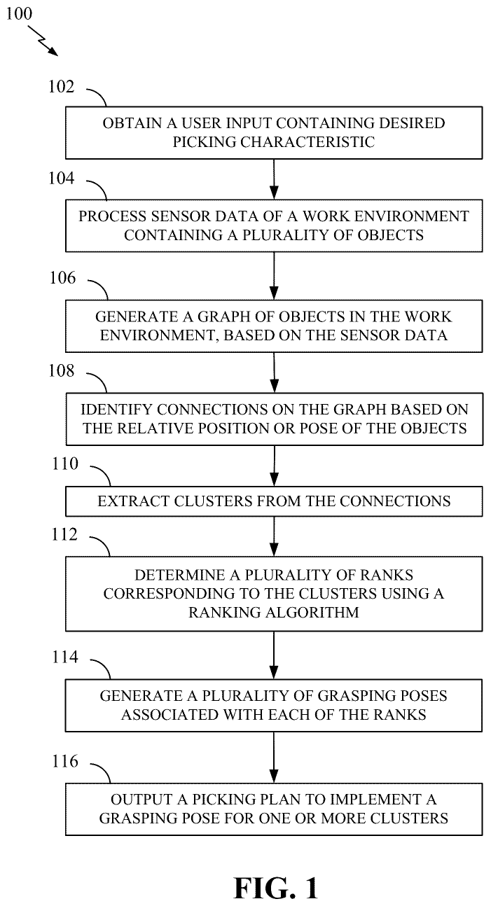

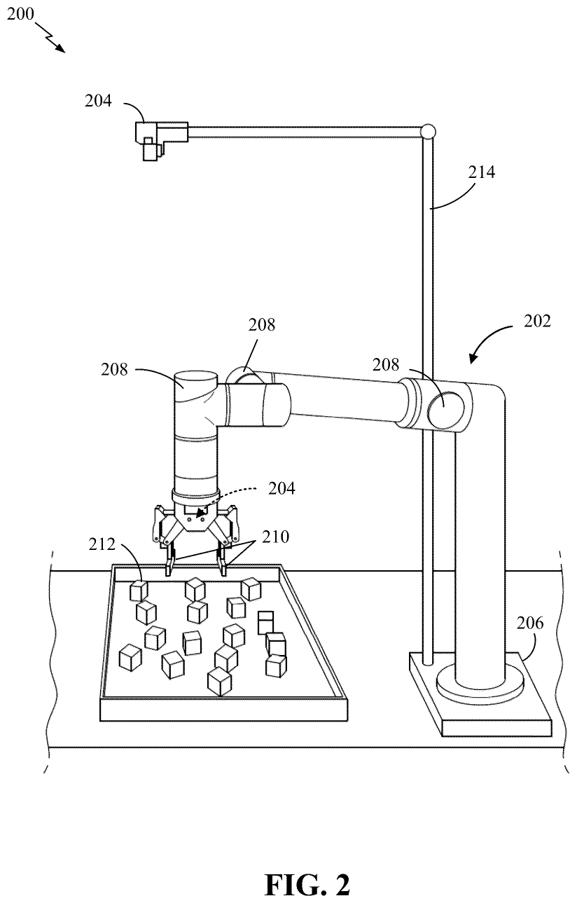

First, some generalized techniques for determining and deploying picking plans or schemes for multi-object picking will be described. FIG. 1 is a flow diagram illustrating an example process 100 for generating a picking plan. As described below, a particular implementation can omit some or all of the illustrated features/steps, may be implemented in some embodiments in a different order, and may not require some illustrated features to implement all embodiments. In some examples, an apparatus such as the robotic device 200 in connection with FIG. 2 can be used to perform all or part of example process 100. However, it should be appreciated that other suitable processing hardware for carrying out the operations or features described below may perform process 100.

At step 102, the process 100 determines a desired picking characteristic. In some examples, a user may input a desired characteristic, or a characteristic may be loaded into a system based upon a given automation process (e.g., a given manufacturing or packing process). The picking characteristic can be a specific picking criteria, or a more general desired approach or a goal. For example, the desired approach or goal may be to pick as many objects as possible in each grasping motion, always pick the same number of objects, use as few grasps as possible, only pick upside down objects, only pick objects indicated as important, and other examples. In other examples, the characteristic may be a specific number of objects, which number can be preset or dynamic. For example, the number of objects may change dynamically to fit the number of objects necessary for fulfilling an order, such as in the logistics and shipping industry. Alternatively, the number of objects may be specific to an object being made or prepared, such as in the manufacturing industry, food preparation industry, shipping industry, and other industries. The number of objects to pick may also be dynamically determined according to a specified criteria other than the number itself (e.g., where the objects to be picked, such as natural food items, may be of slightly varying size and shape), such as a total weight or volume. In such embodiments, the number of objects (or specific target objects) to pick may adjust as the weight of previously-picked objects placed into a container increases. Therefore, the desired picking characteristic of step 102 can take a variety of formats: target weights, target volumes, specific numbers, target number of grasping motions, minimal or maximal goals for grasping motions or objects picked, etc.

At step 104, the process 100 obtains sensor data of a work environment containing a plurality of objects. For example, the sensor data may be an image of the work environment. In some examples, the objects that make-up the plurality of objects may all be the same (e.g., uniform plastic pellets for a molding process, or identical retain items for order fulfilment) or heterogeneous (e.g., non-similar mixed items in a retail bin or shelf). In other examples, the objects may differ from one another even if they are in the same class (e.g., food items). And, the objects to be picked may be present in an unknown mixture of undesired objects (e.g., refuse in a recycling operation, unneeded biomass in an agricultural processing operation, etc.) Therefore, the processing of the sensor data may involve performing a classification or object recognition task in order to detect objects and/or obstacles. In some examples, the sensor data may be captured using an image sensor (e.g., a RGBD vision sensor). In other examples, the image sensor can be a 2D or 3D camera. The sensor may include laser/LiDAR, IR, point cloud, or other similar techniques that need not involve image generation or processing. The sensor may be electrically coupled to a processor and the robotic device. In some examples, the sensor data may be an image or video stream from a top-down view of a flat or horizontal work environment, or a lateral view of a vertical work environment such as shelves. In other examples, the sensor data can comprise a CAD model of the work environment containing the plurality of objects, or other information that predefines the placement of objects in the work environment.

At step 106, the process 100 generates a graph based on the image of the work environment. The graph may contain coordinates associated with locations within the work environment, as well as coordinates associated with the location of the robotic device within the work environment. In some examples, the graph may comprise location information of each object in the work environment.

At step 108, the process 100 identifies connections on the graph based on the relative position or pose of the objects. Connections may be made between each object and one or more other objects located closest to the object of interest. For example, distance values between objects and each object's location information can be used to identify the connections. In some examples, the pose or orientation of the object may be used to create or define connections (e.g., cylindrical objects that are standing vertically on their flat ends may be clustered with other vertically-oriented objects or may be prevented from being part of a cluster with objects lying horizontally, or certain object classes may have profiles that would not be amenable to multi-object grasping when posed in certain orientations relative to one another). In other examples, one or more extraneous objects or obstacles may be identified. In this example, connections may be omitted from one or more objects which share a close proximity or overlap with one or more extraneous objects or obstacles.

At step 110, the process 100 extracts clusters from the connections. The clusters may comprise one or more objects and may be identified on the graph. In some examples, the clusters may be normalized on the graph. In some examples, the number of objects in each cluster may correspond to the desired amount of objects to pick. The below description may provide one or more example processes for forming clusters from connections. In some examples, clusters may be determined using a capacity of the grasping mechanism involved. Thus, the process 100 may take into account the maximum ‘open’ width between grasping paddles/fingers as well as the size of the paddles/fingers themselves to define a maximum area within which objects must entirely reside in order for them to be grasped by the grasping mechanism in a close/grasp operation. For example, connections may be formed between one or more objects which fit within the opening distance of the paddles.

At step 112, the process 100 determines a plurality of ranks corresponding to the clusters using a ranking algorithm. The location information of each object may also be used to determine the plurality of ranks. In other examples, the clique orders of each object and their connections with out-clique objects or nodes may be used to determine the ranks. In some examples, the ranking may comprise a confidence threshold which may indicate the probability of picking the desired number of objects. A heuristic process may be used to determine the plurality of ranks. For example, the heuristic process may use the probability of the paddles colliding with the objects when determining ranks. In other examples, the number of possible poses may be used to determine ranks, such that clusters having the greatest number of possible poses are more highly ranked that clusters having only one or very few possible poses. By ranking clusters in this manner, the “easiest” clusters to grasp will be picked first.

In alternative embodiments, when it is known that multiple grasping actions will take place, the ranking process may take into account the effect that removal of a cluster of objects will have on possible poses for other clusters. Thus, where a given cluster may not have the most possible poses, it might still be ranked higher if picking that cluster from the workspace would result in freeing up multiple additional grasping poses for other clusters. For example, process 100 may determine a number of grasping actions that will be used for a multi-grasping operation. This number will be used to define the number of levels of a path planning decision tree. The n top-ranked clusters may be the starting points of the decision tree, or any cluster having at least a threshold number of possible poses may be the starting points. Then, process 100 may evaluate the impact of removal of each cluster on the other clusters, iteratively until the sequence of cluster picking that allows for the “easiest” grasping operations to be performed will be selected. Or, the sequence of cluster picking that allows for the least number of grasping operations to be performed, etc. Other similar algorithms may be used, such as various shortest path-style algorithms, minimization algorithms, or other machine learning techniques.

At step 114, the process 100 generates a plurality of grasping poses associated with each of the ranks. In some examples, ranks are generated for the cluster with the highest rank values. Each grasping pose may be categorized as a “collision-free” pose or a “not collision-free” pose. In some examples, the not collision-free poses may be eliminated. In other examples, ranks may be generated based on whether a pick would make other clusters collision-free, when multiple picking runs are used. Thus, the process 100 may filter out invalid possible poses for a given cluster based on a variety of criteria such as: number of objects, pose of objects, potential collisions, etc. Then, a pose will be chosen for each cluster; if more than one grasping pose is possible, then the grasping pose that will be most efficient given the previous grasping motion (e.g., will require the least motion of the robotic arm) or other similar consideration will determine the pose to be used.

At step 116, the process 100 outputs a picking plan containing the plurality of grasping poses. In some examples, the picking plan may be received by the robotic device. In other embodiments, the process 100 may output specific inputs to the motors operating the robotic arm and grasping mechanism, rather than an overall plan, that would cause the planned grasping techniques to be performed.

In some examples, outputting the picking plan may comprise creating a pair by matching the picking plan with the corresponding image of the work environment, or by matching the picking plan with information extracted from the corresponding image (e.g., a segmentation showing only objects of interest). This pair may be stored in a training dataset. The training dataset may be supplemented with data pairs from other sources as well, e.g., human-generated picking plans, or subsequent pairs may be grouped together where they represented a multi-grasp operation. In other embodiments, the training dataset can be modified to reinforce successful grasping operations versus failed grasping operations. Once a sufficient amount of training data is generated, the data can be used to train a machine learning model, such as a deep neural network model, etc. so that an “end-to-end” approach can be used in which sensor data is provided to the trained model as an input, and the model outputs an optimized picking plan.

In yet further embodiments, the process 100 may be utilized specifically to generate training data. In such embodiments, a randomized simulator may be employed to generate images of objects in simulated work environments. The simulation images may be provided to process 100 to generate (or to supplement) a training data set for training a machine learning model.

FIG. 2 is an example robotic system 200 for picking objects according to some embodiments. The robotic system 200 may generally comprise a robotic device 202, a sensor 204 (or input to receive sensor data), and a base 206. Moreover, the robotic system 200 may further comprise a memory in communication with a processor, which may be housed within the base 206. The processor may be configured to execute instructions embodied in the memory to perform one or more steps of a process (e.g., process 100).

In some examples, the robotic device 202 may comprise a multi-axis arm with one or more motors 208 to control movement in each axis. The robotic device 202 may further comprise a grasping mechanism, which may include grasping paddles or fingers, or other means of using opposing pressure to grasp, scoop, or hold objects. As shown, the grasping mechanism comprises paddles 210, which are designed to grasp one or more objects 212 in an environment. The plurality of grasping poses of the picking plan outputted at step 116 of process 100 may contain instructions to move both the motors 208 and the paddles 210, for specific positioning relative to the objects 212.

The sensor 204 may be any of a variety of possible sensor types, such as an optical camera, 3D depth sensor, laser/LiDAR sensor, etc. The sensor 204 may be attached to a stand 214 connected to the base 206, or otherwise affixed in a static location that provides optimal viewing of the workspace. In other examples, the image sensor 204 may be attached to the robotic device itself, such as proximate to the grasping mechanism. In some examples, the image sensor 204 can be a Red Green Blue Depth (RGBD) vision sensor. In other examples, the image sensor 204 can be positioned above or to the side of the environment.

### Example Embodiments and Experimental Findings

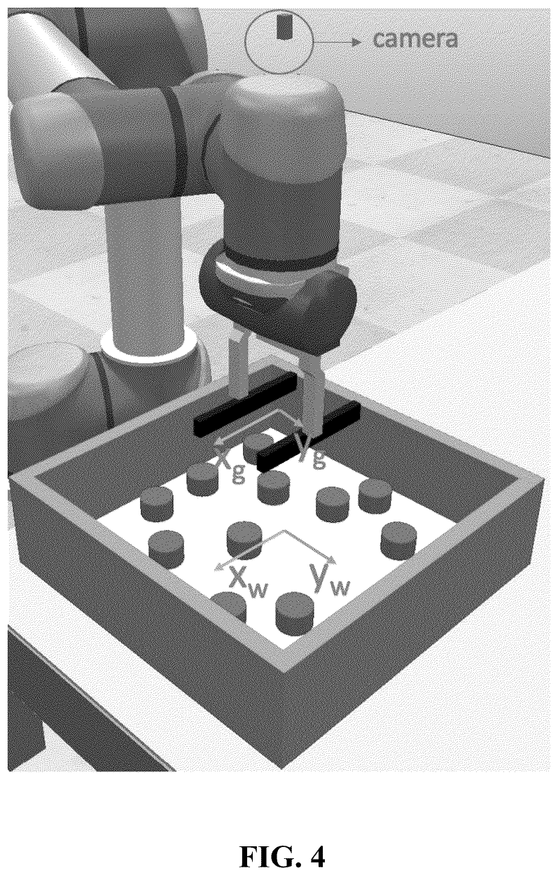

FIG. 4 shows an example robotic system in a simulation environment, per testing performed by the inventors. The system has an RGBD vision sensor, 6-axis robotic arm (UR5), and a simple “bang bang” parallel gripper (e.g., of the type logistics environments usually prefer given low-cost pneumatic grippers). The gripper simulates a “bang bang” gripper, only allowing full close and open. However, it is understood that a grasping mechanism may include programmable or dynamic closing functions and/or sensors housed within the grippers to automate closing relative to a desirable pressure.

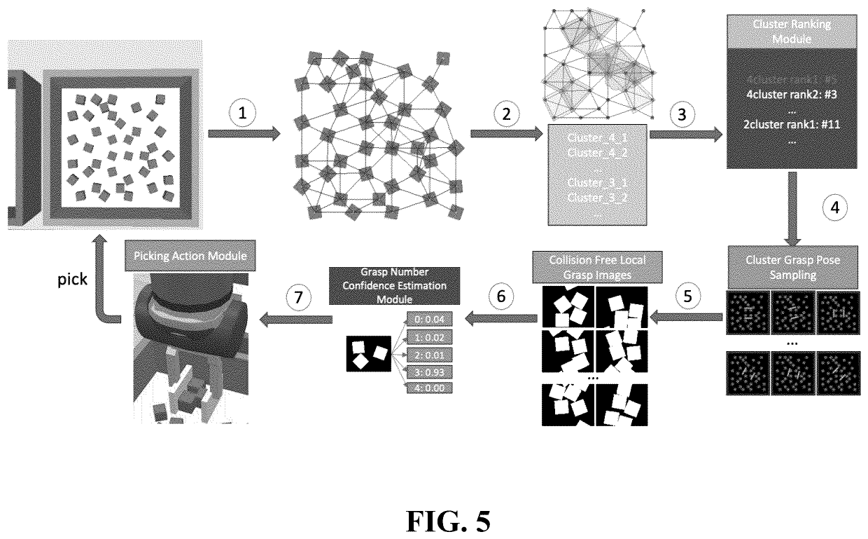

FIG. 5 provides an overview of another example system per the concept of OPO. Two inputs to the system are: a single RGBD image sensor—the output of which provides a top view of the bin; and the desired number k of objects to be picked up. It can be assumed that k is smaller than the max preset number m based on the capability of the gripper for the objects of interest. The OPOS has a set of algorithms that process the image through seven modules and outputs a 2-DOF planar position (x,y) and an in-plane rotation γ to the robotic arm for picking.

Module 1 of the example OPOS is called neighbor graph generation. In this module, an algorithm processes the RGBD image (e.g., using computer vision techniques), detects and extracts the objects within the image, determines their locations within the work environment, and generates a neighbor graph based on their relative positions.

Module 2 is called clustering, in which clusters of k to m objects in the neighbor graph are identified. The clusters may be determined according to either a specified number of objects per grasp, or via min/max goals (e.g., the minimum number of clusters, which have the maximum number of objects).

In Module three, called cluster ranking, the clusters are ranked based on a set of rules and stored in the ranked cluster list based on their ranking. The first cluster in the ranked cluster list will be checked through the following three modules. If it is eliminated, the next cluster in the list becomes the top-ranked cluster and will be checked until the list runs out of clusters.

In Module 4, picking pose proposal, a sampling algorithm proposes several picking positions and orientations for the top-ranked cluster. In Module5, collision checking, the proposed picking poses are checked for collision. The collision-free poses are kept in a picking pose list. If there is no collision-free pose, the cluster is eliminated. In Module 6, picking confidence estimation, a trained neural network, e.g., a multi-object picking predictor, takes the local scene between the gripper fingers of a proposed pose in the picking pose list and estimates the confidence of picking up zero, one, two, and up to m objects with that picking pose. In Module7, picking pose selection, the picking confidences of picking k objects of various picking poses and clusters are compared with a pre-defined threshold and among themselves. The optimal picking pose is selected for execution.

Neighbor Graph Generations: To pick up more than one object, the relationships among objects can be evaluated and the ones the gripper could pick up together can be connected. Therefore, in the neighbor graph generation module, an algorithm (e.g., an operation performed by a software process of process 100) analyzes the input RGBD image, localizes the objects in the bin, and generates a neighbor graph of objects based on their relative locations. So, the algorithm for this module has two parts: object center detection and graph generation.

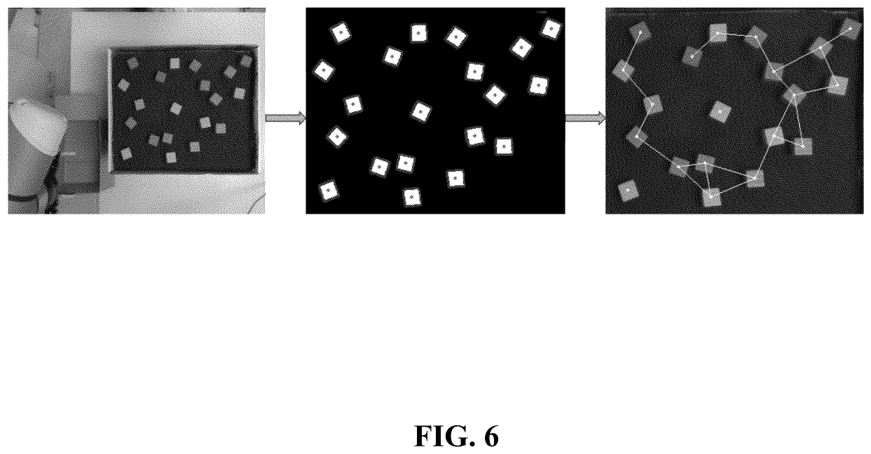

An RGBD camera right above the bin takes an image of the bin with objects inside. The algorithm first segments objects in the bin from the background, detects their contours and then estimates their centers. The algorithm then treats each object as a node and connects it with its neighbor nodes within a predefined distance. The neighborhood distance threshold H_{d} is defined based on the gripper specifications. FIG. 6 illustrates the two modules in the process using an example.

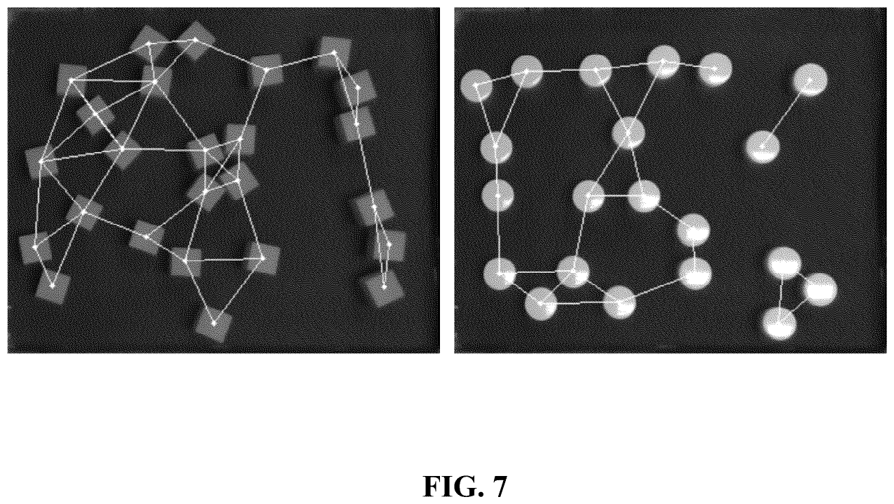

The final neighbor graph is an un-directed weighted graph G={N,E}. The nodes set N contains the object indices and their location information. The edges set contains the connections and distance values. FIG. 7 shows two more example neighbor graphs. In this module, the neighbor graph is generated, and the image of the bin area is normalized so that each pixel of the image represents a 1 mm×1 mm area in the real space for the next modules.

Clustering: To pick up k objects, the clusters with at least k objects need to be identified, the same as finding a k-clique in the neighbor graph. A k-clique means a k-complete graph where all k nodes are fully connected. Therefore, the goal is to identify all cliques of k order or higher in the neighbor graph. The cliques with orders lower than k are discarded and the remaining are saved in the initial cluster list (ICL).

The clique requirement is relatively loose; not every cluster in ICL could fit in the open gripper. First, the effective gripping area of the open gripper is calculated. The width of the effective gripping area is defined as the gripper's open spread (distance between the gripper fingers). The length of the effective gripping area is defined as the length of the gripper finger plus one target object length (counting the half-target object length at both ends of the gripper finger). It is a generous definition since when the gripper closes, the object will usually slide out of the gripper if only a small portion of the object is in between the gripper fingers at the beginning. Therefore, if the center of an object is not in the effective gripping area, the object cannot be picked up by the gripper.

Algorithm 1 checks if all objects of each cluster in ICL can fit in an effective gripping area. For each cluster, it first calculates the convex hull of all objects in the cluster, then uses the convex hull points to calculate a minimal area rectangle to enclose the entire convex hull. This rectangle is called the cluster rectangle. Min_Area_Rec subroutine takes in a cluster and outputs the cluster rectangle. Rec_in_Rec subroutine takes in two arguments and checks if the first rectangle can fit in the second rectangle.

Algorithm 1: Cluster fit in EGA checker

| Input: Initial Cluster List (ICL), and Effective | |
|---|---|
| Gripping Area (EGA) | |
| Output: Remained Cluster List(RCL) that can fit in | |
| EGA. | |
| 1: | RCL ← { } |
| 2: | for i ← 1 to len(ICL) do |
| 3: | min_area_rec ← Min Area_Rec(ICL[i]) |
| 4: | fit_in_flag ← Rec_in_Rec(min_area_rec, EGA) |
| 5: | if fit_in_flag then |
| 6: | RCL.append(ICL[i]) |
| 7: | end if |
| 8: | end for |
| 9: | return RCL |

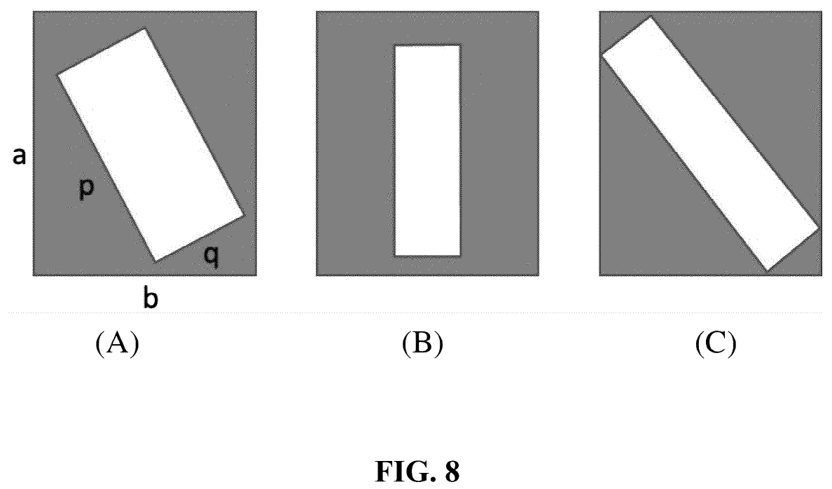

To test if the cluster rectangle can fit in the effective gripper area, the rec-in-rec theory is used. According to the rec-in-rec theory, as illustrated in FIG. 8A, the yellow rectangle (p×q area, q≤p) can fit in the red rectangle (a×b area, b≤a) if and only if either of the following conditions is true:

$$\begin{matrix}( a ) p \leq a and q \leq b \\ ( b ) p > a , q \leq b , {and ( \frac{a + b}{p + q} )}^{2} + {( \frac{a - b}{p - q} )}^{2} \geq 2\end{matrix}$$

Here, the cluster rectangle is the yellow rectangle, while the effective gripper area is the red rectangle. After obtaining their widths and heights, it is checked if the two sets of widths and heights satisfy either of the conditions. If yes, the cluster is kept in the cluster list (CL). Otherwise, it is eliminated. FIG. 8B shows one example of condition (a), while FIG. 8C shows one example of condition (b).

Cluster Ranking: To quickly find a suitable cluster among all clusters in CL for picking up k objects, an algorithm (Algorithm 2) has been developed that will rank them based on their clique orders and the likelihood of finding a collision-free picking pose. Weight_Sum subroutine calculates the external connection weight sum for every cluster, and SORT subroutine ranks CL based on the weight, a higher weight cluster will be ranked lower since it is prone to be closer to external objects. First, the algorithm ranks all clusters in CL based on their clique orders. Since the goal is to pick up k objects, the clusters with the clique order of k should rank highest, followed by clusters with the clique order of k+1, and so on. The likelihood of finding a collision-free picking pose can be associated with how isolated the cluster is from other objects in the bin. If a cluster is more isolated than another cluster, it is more likely to find a picking pose from where the arm can lower the gripper to the bottom of the bin collision-free.

Algorithm 2: Cluster Ranking

| Input: Clusters List (CL) contains all clusters of a | |
|---|---|
| given order | |
| Output: Ranked Cluster List (RankCL) | |
| 1: | weight_list ← { } |
| 2: | for i ← 1 to len(CL) do |
| 3: | current_weight ← Weight_Sum(CL[i]) |
| 4: | weight_list.append(current_weight) |
| 5: | end for |
| 6: | RankCL ← SORT(CL, weight_list) |
| 7: | return RankCL |

It was found that an existing clique isolation factor does not fit this problem well since it doesn't consider how close the connected nodes are, which is an important factor in gauging the risk of collision. Therefore, an external crowd index is defined. It puts more weight on the ones that are close to the clique. The weights wᵢ are calculated based on Equation 1.

$$\begin{matrix}Δ l = \frac{{H}_{d} - width}{5} \\ {w}_{i} = 5 - round ( \frac{{d}_{i} - width}{Δ l} ) \\ wif = \sum {w}_{i}\end{matrix} \qquad ( 1 )$$

where H_{d} is the Neighbor Distance Threshold, and width is the effective width of the object. For each edge that is connected to the clique, its length dᵢ is converted to weight. The weight is between 1-5. It is inversely proportional to the edge length. The total weight of all edges connected to the clique is its external crowd index. Since it is used for ranking, normalizing it is unnecessary.

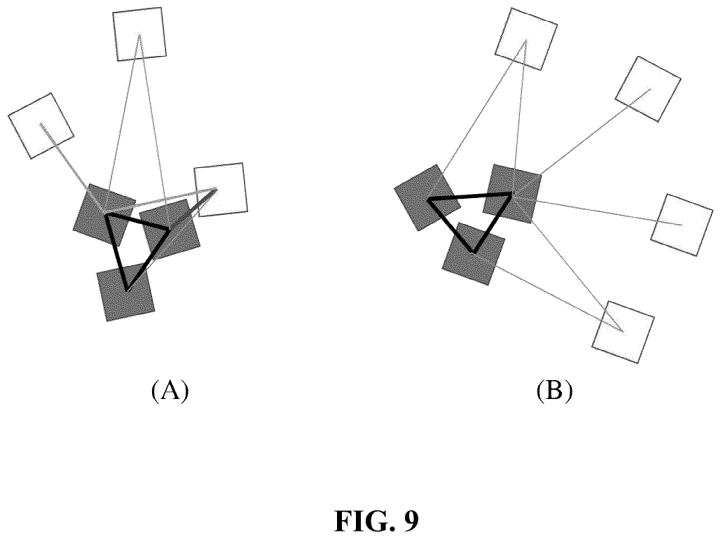

FIG. 9 illustrates how the external crowd index calculation uses the edge distances. Both examples FIG. 9 have two 3-clusters; their objects are marked as blue, and the neighbor objects to the cluster are marked as yellow. The cluster in FIG. 9A has four edges connecting to three external objects. Based on their lengths, their weights are 5, 4, 4, and 1. So, its external crowd index is 14. The cluster in FIG. 9B has six edges connecting to four external objects. Based on their lengths, their weights are all 1's. So, its external crowd index is 6. It can be seen that even though the cluster in FIG. 9B has four external neighbors and its isolation indicator is worse than the cluster in FIG. 9A, its external crowd index is less. It is consistent with our intuition that picking the cluster in FIG. 9A has a higher risk of collision than picking the cluster in FIG. 9B. So, the cluster in FIG. 9B is ranked higher than in FIG. 9A.

The cliques in CL are ranked based on their clique orders first and then crowd indices to break the ties. The cluster with k nodes and the smallest crowd factor will rank at the top.

Picking Pose Proposal: Once a candidate cluster is selected based on the ranking, this approach will process the layout of the objects in the cluster and then propose several gripper-picking poses that could pick up k objects. It is advantageous that the approach to propose several poses instead of just one because many of them may not pass the collision check in the next module. Since the objects are identical and lying un-stacked in a box, the picking height is fixed and can be calculated. This approach will focus on obtaining the picking in-plane position and orientation and define them as x, y, and γ. The cluster center (cₓ, c_{y}) is computed in the world coordinate system and define γ=0° when the gripper's x_{g} axis is aligned with the world x_{w} axis. The definition of world and gripper axes are shown in FIG. 4.

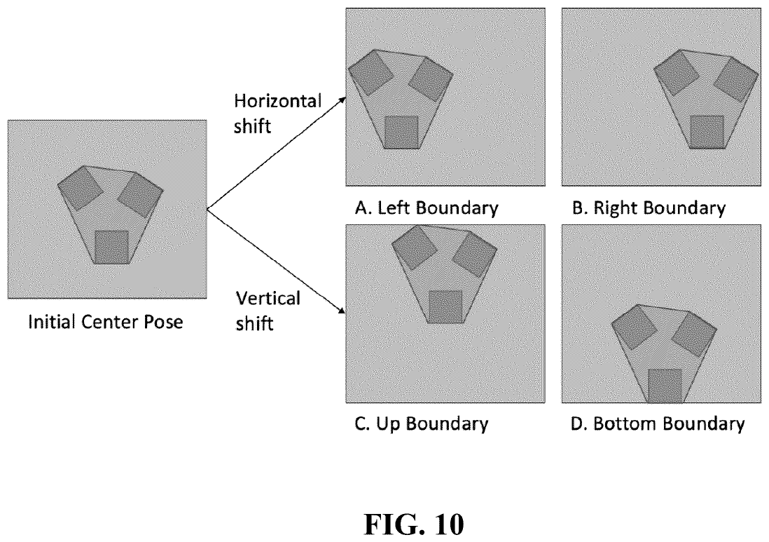

To propose poses, the 12 γ's are first sampled from 0° to 165° (the gripper is symmetric) since it was found that the outcomes of two picking poses are similar if they are different by less than 15°. To sample the positions at each γᵢ, the gripper is rotated by γ relative to the world coordinate system and sample along the rotated gripper axes x_{g} and y_{g}. The sampling range along x_{g} and y_{g} are computed to ensure the pose's effective gripping area still encloses the object's convex hull as shown in FIG. 10. It was found that overly fine sampling will increase computation costs and generate many poses that produce the same outcome. Therefore, samples were taken 10 steps each from the center to the left/right/up/down to their ranges if the ranges are larger than 20 mm. Otherwise, samples were taken 2 mm for each step since poses with less than a 2 mm difference would produce very similar outcomes.

Algorithm 3 describes the procedure to sample picking poses on a given cluster for 12 degrees. For each rotation, the first four boundaries of the EGA were picked to cover the cluster using the GetBound subroutine. Then, it was check if the current direction's bound is possible to cover the cluster. If one direction can cover the cluster, the GetStepSize subroutine was used to calculate the x and y direction step size according to the procedure illustrated above.

Algorithm 3: Picking Pose Sampling Algorithm

| Input: Convexhull Points Set (CPS) of a given | |
|---|---|
| cluster. x direction length of EGA in mm (a), y | |
| direction length of EGA in mm (b) | |
| Output: Sampled Picking Poses List (SPL). | |
| 1: | SPL ← { } |
| 2: | for i ← 0 to 11 do |
| 3: | γ ← i×15 |
| 4: | bound_list ← GetBound(CPS, γ) {0-3 in bound_list |
| | are left, right, bottom, and up bound} |
| 5: | x_length ← bound_list[1]-bound_list[0] |
| 6: | y_length ← bound_list[3]-bound_list[2] |
| 7: | if x_length > a or y_length > b then |
| 8: | continue {at this angle cluster cannot be covered |
| | by EGA} |
| 9: | end if |
| 10: | x_step, y_step ← GetStepSize(x_length, y_length) |
| 13: | sampled_poses ← { } |
| 12: | x←bound_list[0] |
| 13: | while x<bound_list[1] do |
| 14: | y←bound_list[2] |
| 15: | while y<bound_list[3] do |
| 16: | sampled_poses.append(x,y,γ) |
| 17: | y += y_step |
| 18: | end while |
| 19: | x += x_step |
| 20: | end while |
| 21: | SPL.appends(sompled_poses) |
| 22: | end for |
| 23: | return SPL |

The samples along x_{g} and y_{g} are then converted back to the world coordinate system. With γ, they are associated with the cluster as its picking-pose proposals.

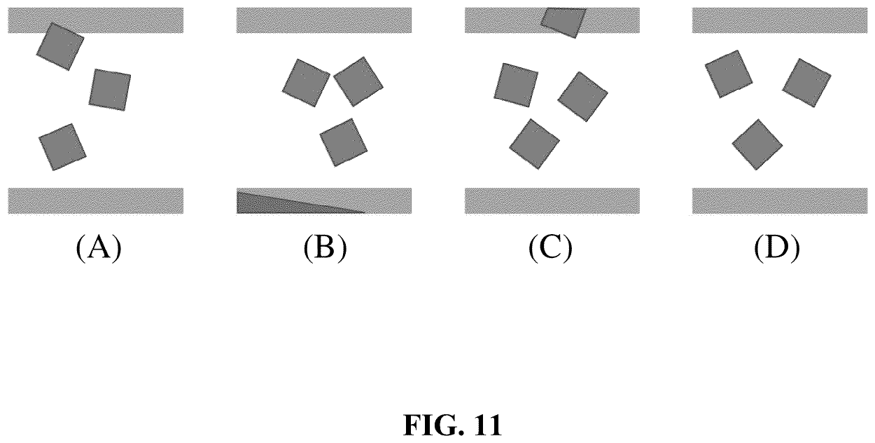

Picking Pose Collision Checking: A picking pose that would lead to a collision between the open gripper and the objects shouldn't be choosen. It is assumed that the workspace of the gripper has been confined based on the bin's location and geometry. So, the algorithm checks the collisions in the projected 2D plane since the objects are identical and lying un-stacked. FIG. 11 illustrates three typical collisions and a collision-free layout. FIG. 11A-C are three collision examples with internal object, bin, and external object, FIG. 11D is a collision-free example. Any proposed picking poses leading to a collision are removed. At this point, there is a cluster list in which each cluster has a list of collision-free picking poses.

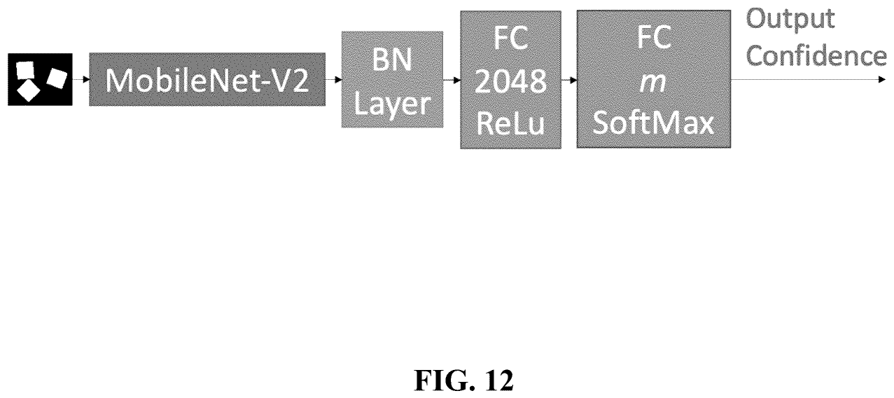

Picking-Confidence Estimation: Using a proposed picking pose, one can obtain a local image of its effective gripping area. This is called the gripping area image. The size of this gripping area image is based on the size of the gripper as it describes the layouts relative to the gripper before grasping. There is no further processing besides the cropping step. The pattern was used in the gripping area image to predict how many objects the gripper will pick up when only picking once. To learn the patterns, a deep neural network structure has been structured that uses the MobileNet-V2 for feature extraction and a fully connected (FC) ReLU layer combined with a softmax output layer as a classifier. For efficient training, a batch normalization (BN) layer was used between the MobileNet-V2 and the ReLU layer, as shown in FIG. 12. The output of the network gives the confidences of picking from 0 to m objects. The neural network is called the multi-object picking predictor.

For each cluster, the gripping area images generated using all the proposed picking poses were inputted to the multi-object picking predictor in a batch and receive their confidences in picking 0 to m objects. If the desired number of objects is k, the picking poses with the highest confidence at the k bit are kept; the rest are discarded. If all proposed poses of a cluster are discarded, the cluster is removed from the CL.

Two MOP predictor models were trained: one for the short gripper and one for the long gripper. The short gripper MOP predictor model is trained with the images of 92,433 random layouts of two small objects: a 1-inch cube and a 2.8-cm cylinder. The long gripper MOP predictor model is trained with the images of 96,836 random layouts of three large objects: a 2-inch cube and 3.8 cm cylinder, and a cuboid. The full list of the objects used both in training and testing is in Table 1. Each layout has 2-m objects randomly placed in the effective gripping area. Their labels are obtained with their picking outcomes in simulation. The MobileNet-V2 has been pre-trained on ImageNet. To train the rest of the neural network, the Adam optimizer was adapted with a fixed 1e-4 learning rate and loss function as Categorical Cross-entropy. The dropout rate was set at 0.3 for the fully connected layer.

Selecting Pose With High Picking Confidence: So far, this approach processes the object layout in the bin and produces a list (CL) of ranked clusters and their proposed picking pose with their confidences in picking k objects. One could simply go through all clusters in CL and their proposed picking poses and pick the picking pose with the highest confidence of picking k object to execute. However, it is a brute-force approach and could take too much time if many clusters are in a large bin.

Algorithm 4: Action Selection based on confidence

| Input: List of clusters to be inspected (CL). Target | |
|---|---|
| number k. Confidence threshold H_{c} | |
| Output: An action if available, or None if there is | |
| no action found. | |
| 1: | backup_list ← { } |
| 2: | for i ← 1 to len(CL) do |
| 3: | sampled_poses ← SamplePose(CL[i]) |
| 4: | valid_poses ← CheckCollision(sampled_poses) |
| 5: | local_images ← GetLocalImage(valid_poses) |
| 6: | prediction ← Picking_Predictor(local_images) |
| 7: | max_confidence, index ← Max_Conf(prediction, k) |
| 8: | if max_confidence> H_{c} then |
| 9: | return valid_poses[index] |
| 10: | else if max_confidence>0 then |
| 11: | backup_list.append(index,max_confidence) |
| 12: | end if |
| 13: | end for |
| 14: | if backup_list! = { } then |
| 15: | optimal_index ← Max_Conf_Index(backup_list)[0] |
| 16: | return valid_poses[optimal_index] |
| 17: | end if |
| 18: | return None |

Algorithm 4 shows the procedure to find an action based on the target number and confidence threshold. SamplePose Subroutine calculates sampled poses based on one cluster. CheckCollision Subroutine filters out poses that have a collision with objects or the bin. GetLocalImage gets the corresponding local image for each picking pose. Max_Conf Subroutine gets the max_confidence for all local images that predict to pick k objects, index is the corresponding index of this instance. If no pose predicts on k, then the max_confidence will be set as 0. If the max_confidence for one cluster to pick k objects is above H_{c}, then the picking pose is returned and executed. If the max_confidence for picking k is below H_{c}, then this action is stored as a backup until the end if no picking pose's confidence is over the threshold. If all clusters are checked and no action higher than the threshold is found to pick k objects, then the action with the highest confidence in the backup list is selected and passed to the robot. Since efficiency is the goal, we set a good-enough confidence threshold H_{c} and start checking from the highest-ranked cluster in CL. The selection of the good-enough confidence threshold H_{c} is described in below. When a collision-free picking pose is found with the confidence of picking k object over H_{c}, it is sent to the robot to execute. This way, one doesn't need to run through the modules from Picking Pose Proposal to Picking-Confidence Estimation for all clusters in CL. However, for some difficult layouts, it is possible to run through all clusters in CL without seeing one pose with over H_{c} confidence. Then the algorithm falls back to the brute force approach.

If the CL is empty because either no cluster has been found or all cluster has been eliminated in the process, the process will report failure and reject the request of picking k objects with one pick.

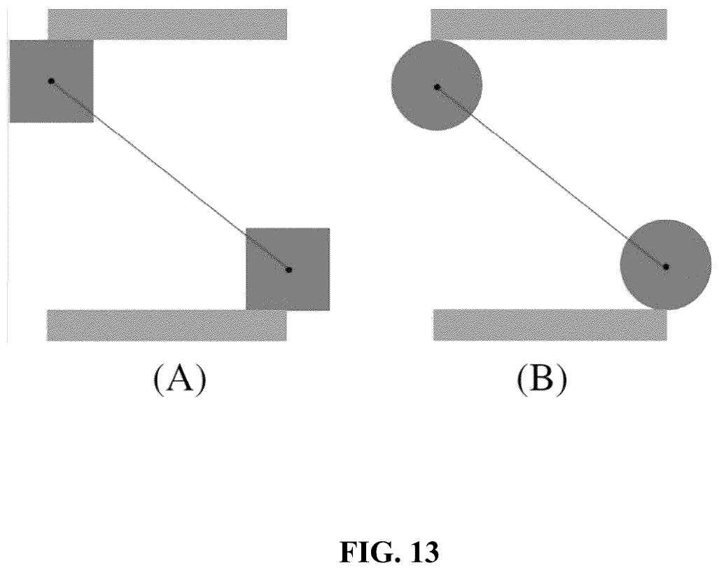

Parameter Calculation and Selection: If two objects are too far apart, they cannot be picked together by the gripper if only picking once. The farthest distance between two objects that could still be picked together is defined as the Neighbor Distance Threshold H_{d}. When the centers of two objects are at the diagonal corner of the open gripper, they are farthest apart but still could be picked up together, as shown in FIG. 13. The threshold H_{d} is computed based on the gripper and object sizes. FIG. 13A and FIG. 13B, respectively, have 9.5 cm and 9.4 cm as their thresholds.

The good-enough confidence threshold H_{c} is introduced to early stop the search for the cluster and picking pose with the highest confidence of picking k objects. It should be set to limit the computation without sacrificing much of the success rate. If H_{c} is set too low, the search will stop very early and a picking pose with a low confidence will be used and the execution outcome would have a lower chance of picking up k objects. On the other hand, if H_{c} is set too high, the search will skip through many good picking poses and will not stop until going through all clusters and proposed poses.

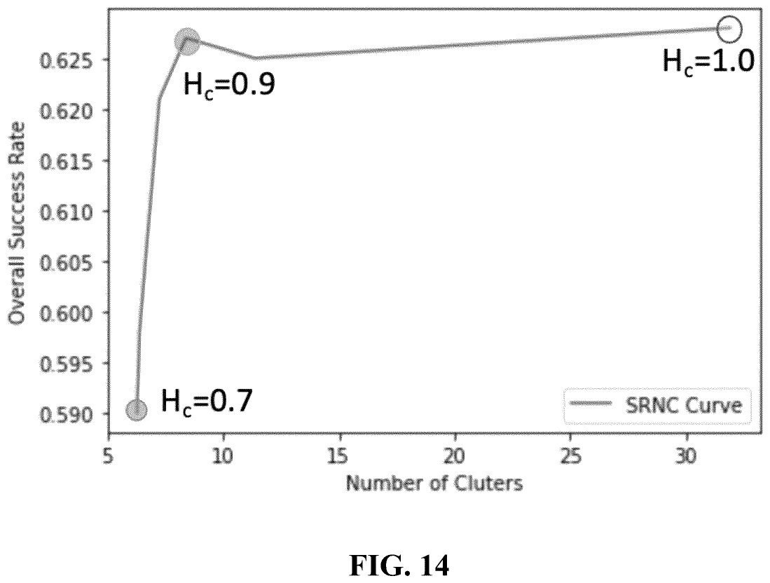

To select the proper H_{c}, an experiment was designed to obtain the success rate and number-of-clusters (SRNC) curve for picking three 1-inch cubes in the simulation. The curve is plotted with seven thresholds: 0.7, 0.75, 0.8, 0.85, 0.9, 0.95, and 1 (no early stopping). As shown in FIG. 14, when the threshold increases, the overall success rate improves while the computation cost also increases. 0.9 was selected as the threshold because its corresponding success rate is close to the one without early stopping, while the average computation time is more than 70% less than without early stopping. The 0.9 threshold is selected after testing on a cylinder and 1-inch cube in simulation based on balancing between the cost of the number of clusters to inspect and sacrificing success rate.

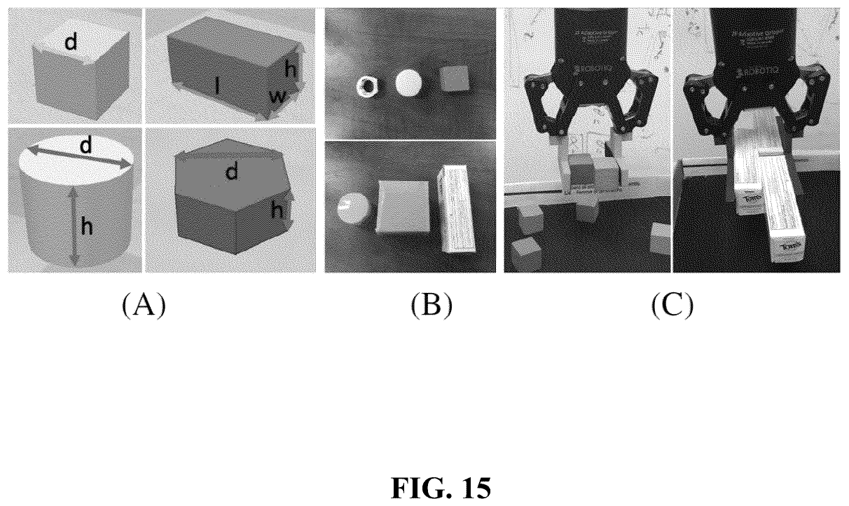

Experiment and Evaluation Setup: FIG. 13 shows the setting of the target objects and the grippers. FIG. 15A shows four types of objects used for evaluation and their corresponding size metrics. FIG. 15B shows the target objects used to evaluate our algorithms in the real-world setup. All objects were divided into two sets based on their sizes and design grippers for them accordingly. For the three objects in the upper part of FIG. 15B, a gripper was designed with 7.5 cm length and 8.4 cm spread. The length is around three times as the 1-inch wood cube side length, and this gripper is shown in the left half of FIG. 15C. For the three objects in the lower part in FIG. 15B, a gripper was designed with 15.0 cm length and 8.4 cm spread. The length is around three times the 2-inch gift box side length.

The base size of the bin used in the real setup is 30.5 cm×38.1 cm. It is the size of a standard storage bin. The bin was selected with a short height for better visualization. In the simulation, a 38.0 cm×38.0 cm bin was used. The bin height is arbitrary as there is collision checking with the container boundary. The two setups have different bin sizes, and our algorithms work equally well on both setups. The algorithms are not sensitive to the bin size.

Since one important target of the OPOS is logistic applications, three common shapes in warehouses were selected. They are cube, cylinder, and cuboid. They are common packaging or container shapes. So, in the real setup, cardboard packaging boxes, small- and medium-sized cosmetic jars, toothpaste boxes, and wood cubes were used. Then, hexagonal nuts commonly used in manufacturing were selected to evaluate the generalization capability of the proposed approach. The sizes of the objects in the simulation are designed to match the ones in real. Table 1 lists all shape types, their indices, and the gripper used for picking. Their dimension parameters are defined in FIG. 15A and the dimension specifications are shown in Table 1. The bold font in Table 1 indicates the object is not in the training set, and * indicates the object is also tested in the real setup. Overall, the proposed approach has been evaluated on 12 different objects in simulation and six objects in real. Among them, seven of them are not in the training set. All hexagon objects (nuts) are not in the training set. FIG. 6 shows examples of multi-object grasping of 6 different objects in real setup.

TABLE 1
Object list table. The meaning of the size for each object can
be checked from FIG. 15A. Hereafter, each object is refered to
by its index. A bold font index means the object is unseen in the training
stage, and ending * in an index means this object is also used in real
testing. Note that ellip_s is an elliptic cylinder with a longer
axis of 2.4 cm and a shorter axis of 0.8 cm.

| Shape | Size(cm) | Index | Max Num | Gripper |
|---|---|---|---|---|
| Cube | d: 2.0 | cube_{—}s_{—}s | 4 | Short |
| | d: 2.54 | cube_m_s* | 4 | |
| | d: 3.0 | cube_{—}l_{—}s | 4 | |
| | d: 5.1 | cube_l* | 3 | Long |
| Cylinder | d: 2.3 | cylin_{—}s_{—}s | 3 | Short |
| | h: 2.5 | | | |
| | d: 2.8 | cylin_m_s* | 3 | |
| | h: 2.5 | | | |
| | d: 3.3 | cylin_{—}l_{—}s | 3 | |
| | h: 2.5 | | | |
| | d: 3.8 | cylin_l* | 4 | Long |
| | h: 3.0 | | | |
| Cuboid | l: 10.6 | cuboid_l* | 4 | Long |
| | w: 3.0 | | | |
| | h: 3.5 | | | |
| Hexagon | d: 2.0 | hexa_{—}s_{—}s | 4 | Short |
| | h: 1.0 | | | |
| | d: 2.3 | hexa_{—}m_{—}s* | 4 | |
| | h: 1.0 | | | |
| | d: 2.3 | hexa_{—}l_{—}s | 4 | |
| | h: 1.0 | | | |

Evaluation Metrics and Protocols: Since the goal is to pick up k objects efficiently and accurately for any arbitrary scenes, the following evaluation metrics are defined:
1. Availability rate (AR): among all arbitrary scenes, the percentages of the scenes for which the OPOS believes it could pick up k objects at once;
2. Execution success rate (ESR): among all available scenes for picking k objects, the percentages of the scenes for which the OPOS actually picks up exact k objects;
3. Overall success rate (OSR): among all arbitrary scenes, the percentages of the scenes for which the OPOS picks up k objects with one picking motion, OSR is the multiplication of AR and ESR: OSR=AR×ESR;
4. Number of picking motions (NP): the number of picking motions needed to pick up exact k objects if not required to only pick once.

The difference between OSR and ESR lies at the scenes, for which the approach fails to produce any picking pose. It could happen when the algorithm cannot find a cluster that contains k or more objects. For example, it happens when all objects are sparsely scattered in a bin, and they are all farther apart from each other than the gripper length. Since this paper does not consider pushing motions to gather the objects, the approach would not produce any picking pose for this example. It could also happen when the algorithm cannot find a collision-free picking pose when there are too many objects in the bin, and the gripper is large.

The number of picking motions (NP) provides a direct measure of the efficiency of the approach. The NP of a traditional single-object picking (SOP) approach would be equal to or above k. The proposed MOP approach could pick up k objects with one picking motion for some scenes but may need several picking motions to recover from failures so that the total number of the picked objects is exactly k. If the proposed MOP has an averaged NP lower than k, it would be considered more efficient than the SOP.

To rigorously evaluate the proposed approaches, three evaluation protocols were designed. In the simulation, to obtain reliable OS rates and ES rates in different situations, the following protocol was followed:
Train MOP predictors. Train two MOP predictors.
Create random layouts. For a small object in testing, randomly create 1,000 layouts in five densities—having 20, 25, 30, 35, and 40 objects in the bin. For the median object (3.8 cm cylinder) in testing, randomly created 1000 layouts in three densities—with 10, 15, 20, 25, and 30 objects in the bin. Use the testing layouts collected when training the long-gripper MOP predictor for large objects.
Run MOP algorithms. Run the proposed MOP algorithms on the test layouts given a desired number of objects. The number ranges from 2 to the max number indicated in the column “Max Num” in table 1. The max numbers are selected based on how many objects the gripper can pick up in reality.
Collect evaluation data. For each run, observe and record: the desired number of objects (target), the object index, the number of objects in the bin, if the algorithms find a picking pose, and how many are actually picked up.

In the real environment, the MOP predictors trained in simulation were used without transfer learning in the real setup. So, its protocol doesn't have the “Train MOP predictors” module. The layout numbers are 80 for each object and each density. The rest is the same as the one in the simulation.

To evaluate the capability of generalization, a protocol was designed to test hexagons in both simulation and real. The short gripper MOP predictor trained in simulation with other shapes was used. The rest of the protocols are the same as the ones in the simulation and real.

Success Rate Results: Tables 2 and 3 show the result of the AR, ESR, and OSR in simulation and the real world, respectively. The number in the Obj Index column is the density of objects in the bin before picking. Both tables show the result on three objects seen in the training stage: cube_m_s, cylin_m_s, cylin_l.

TABLE 2
Simulation Success Rate on Trained Objects.

| Setting | Obj Index | | Target | | |
|---|---|---|---|---|---|
| (num of scene) | (density) | Result | 2 | 3 | 4 |
| Simulation | cube_m_s | AR | 100.00% | 77.00% | 10.50% |
| (200) | (20) | ESR | 97.50% | 74.03% | 61.90% |
| | | OSR | 97.50% | 57.00% | 6.50% |
| | cylin_m_s | AR | 100.00% | 95.00% | NA |
| | (20) | ESR | 96.50% | 94.21% | |
| | | OSR | 96.50% | 89.50% | |
| | cylin_l | AR | 100.0% | 79.50% | 8.50% |
| | (10) | ESR | 97.50% | 96.86% | 94.12% |
| | | OSR | 97.50% | 77.00% | 8.00% |

TABLE 3
Real World Success Rate on Trained Objects.

| Setting | Obj Index | | Target | | |
|---|---|---|---|---|---|
| (num of scene) | (density) | Result | 2 | 3 | 4 |
| Real | cube_m_s | AR | 97.50% | 66.25% | 16.25% |
| (80) | (15) | ESR | 96.15% | 77.36% | 76.92% |
| | | OSR | 93.75% | 51.25% | 12.50% |
| | cylin_m_s | AR | 97.50% | 90.00% | NA |
| | (15) | ESR | 94.87% | 95.83% | |
| | | OSR | 92.50% | 86.25% | |
| | cylin_l | AR | 83.75% | 43.75% | 11.25% |
| | (10) | ESR | 97.01% | 91.43% | 88.89% |
| | | OSR | 81.25% | 40.00% | 10.00% |

Table 2 shows the result of AR, ESR, and OSR for the three objects above in the simulation.

It shows that OSR and ESR for all three objects are higher or equal to 96.50% when target #=2. When target #=3, OSR and ESR for cube_m_s, cylin_m_s, cylin_l are 57.00% and 74.03%, 89.50% and 94.31%, 77.00% and 96.86%. When target #=4, OSR and ESR for cube_m_s, cylin_l are 6.50% and 61.90%, 8.00% and 94.12%, the result for cylin_m_s is NA as the Max Num for this object is 3. The AR value of cube_m_s for target #=2, 3, and 4 are 100.00%, 77.00% and 10.50%. A clear trend is that for each setting (identical object, identical density), the AR value significantly decreases when the target number k increases. For cuboid_s_s, cuboid_m_s, and cuboid_l_s, when target #=2, the OSR and ESR are all greater than or equal to 94.50%. When the target number increases, the uncertainty increases, and accuracy drops. Elliptic cylinder is a general version of the cylinder when the major and minor axes are not of the same length. The result of ellip_m shows that AR is 100.00% and ER is 83.50% when target #=2, when the target number increases, AR and ESR both drop due to lack of clusters and increment of uncertainly, which causes OSR drops.

In Real Result Table 3, the result shows that OSR and ESR for object cube_m_s, cylin_m_s, cylin_l are 93.75% and 96.15%, 92.50% and 94.87%, 81.25% and 97.01% when target #=2. When target #=3, OSR and ESR for cube_m_s, cylin_m_s, cylin_l are 51.25% and 77.36%, 86.25% and 95.83%, 40.00% and 91.43%. When target #=4, OSR and ESR for cube_m_s, cylin_l are 12.50% and 76.92%, 10.00% and 88.89%, the result for cylin_m_s is NA as the Max Num for this object is 3. The patterns of AR for different target numbers are identical to the ones in the simulation.

The result from the two tables indicates the following:
OSR and ESR are high for all objects under simulation and real setup when target #=2.
When target #=3 or 4, both OSR and ESR decrease for all objects, and the gap between these two values becomes larger because of AR value decreases when the target number increases, and the reason AR decreases is that there are more unavailable cases without a solution.
ESR for larger target number decreases for the same setting because of randomness and the picking number estimator accuracy.
Under the same setup (identical object, identical density), it is harder to find an available cluster of a larger target number which is one reason causing low AR and thereafter the bigger difference between OSR and ESR. For instance, The OSR rate for cube_m_s in Table 2 is 97.50%, 57.00%, and 6.50% for target #=2, 3, and 4 under the same density 20. The ESR rates for the three densities are 97.50%, 74.03%, and 61.90%. The decrement in OSR is due to one reason there are fewer 3 and 4 clusters under 20 objects density.
Another reason causing lower OSR for larger target numbers is more collision when trying to pick a higher number. In the following contents, we analyze how density affects OSR in Section 5.5.
Furthermore, for each setting (same object, same density), the ESR decreases when the target number increases, this is another reason causing OSR decrease. The reason ESR decreases as the target number increases is that there is more randomness when picking a higher number of objects, therefore the predictor is less accurate on more objects picking.

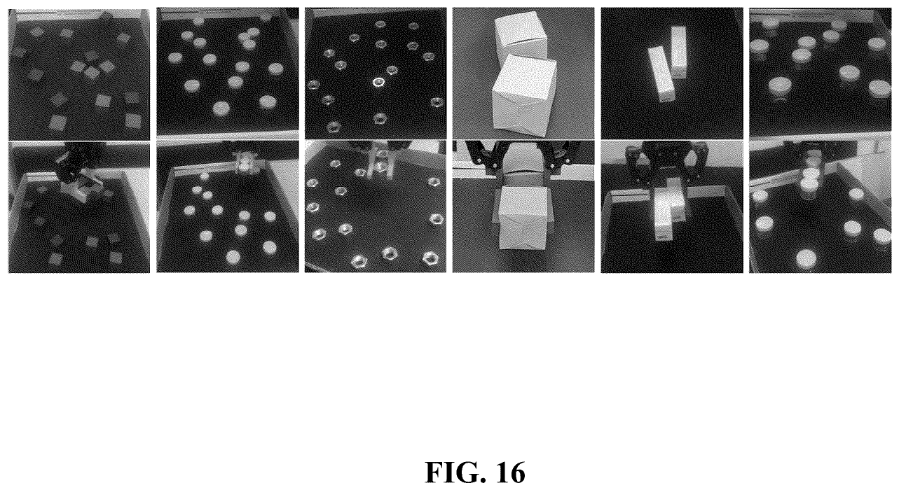

Since it is difficult to fit many large objects: cube_l and cuboid_l in the bin loosely, test layouts were used for the longer griper MOP predictor for evaluation. FIGS. 16A and 16B show the confusion matrix of the testing set in simulation for cube_l and cuboid_l; FIGS. 16C and 16D show the confusion matrix in the real setting for cube_l and cuboid_l. The overall MOP predictor success rates for cube_l and cuboid_l are 96.14% and 97.74% in simulation, 97.00% and 97.00% in real setup.

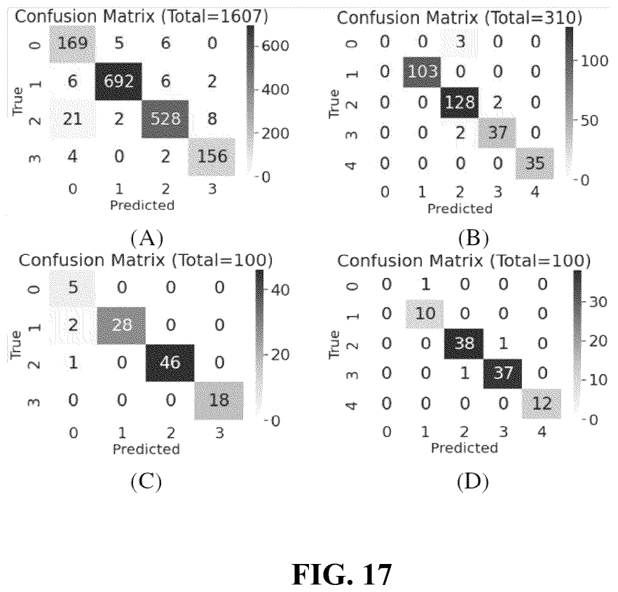

FIG. 17 shows five successful picking examples based on the correct predictions of the trained predictor. The top sub-figure for each column is the object layout in the gripper before closing the gripper. It is also the input to the picking predictor. The bottom sub-figure for each pair is the layout of the objects in the air held by the gripper. The prediction results of the layout A-E are picking up three objects, and the results are correct. FIG. 18 shows three wrong predictions and they will lead to failure. The setting is identical to FIG. 17. The prediction of layout (A) is to get 3 objects, and the gripper really only picked up 2; the prediction of layout B is to pick up 2 objects, and the outcome is 0; the prediction of layout C is to get 2 objects, but the outcome is 1.

Efficiency Evaluation: To compute the number of picking motions (NP), a hypothetical picking and transferring procedure is defined that handles picking failures to make sure the system picks and transfers exactly k objects. One can assume k could be 2, 3, or 4. The procedure runs the proposed approach to searches for a picking pose for p=k. If it cannot find a pose, it will search for a picking pose for p=k−1 and so on, until p=1. If the approach finds a pose, it will be executed, and the output will be either successful or not. If it is successful, the procedure will pick the remaining k−p using single-object picking (SOP). Otherwise, the procedure will handle two kinds of failures in the following ways:
Failure type 1 (FT1)—the number of the picked objects q is smaller than k (including nothing is picked), the procedure runs SOP to pick the remaining k−q objects.
Failure type 2 (FT2)—the number of the picked objects q is larger than k, the procedure runs SOP to pick up q−k objects from the receiving bin.

So, for the cases when p=k and are successful, their number of picking motions is 1. For the cases having FT1, their number of picking motions is 1+k−q. For the cases having FT2, their number of picking motions is 1+k. One can assume that SOP has a 100% success rate. Using the statistics obtained for OSR and ESR, one can compute the hypothetical averaged number of picking numbers to measure the efficiencies of MOP and SOP. Table 5 shows the result of retrieving k objects for cube_m_s and cylin_m_s in real world and simulation. A consistent density of 15 was used in real testing for both objects and five densities (from 20 to 40 with a step size of 5) in the simulation to investigate how the density of objects may affect the result.

TABLE 4
Averaged Number of Picking Motions.

| | | Density | | | | | |
|---|---|---|---|---|---|---|---|
| Object | k | 15(real) | 20 | 25 | 30 | 35 | 40 |
| cube_m_s | 2 | 1.075 | 1.045 | 1.035 | 1.065 | 1.050 | 1.050 |
| | 3 | 1.650 | 1.585 | 1.650 | 1.570 | 1.475 | 1.480 |
| | 4 | 2.350 | 2.470 | 2.510 | 2.435 | 2.315 | 2.145 |
| cylin_m_s | 2 | 1.088 | 1.040 | 1.040 | 1.055 | 1.035 | 1.075 |
| | 3 | 1.200 | 1.150 | 1.085 | 1.145 | 1.095 | 1.115 |

Overall, if the task is to pick and transfer two objects, on average, it would take this approach less than 1.1 picking motions to pick and transfer exactly two objects, while the SOP would need 2. If the task is to pick and transfer three 1-inch cubes, on average, it will take this approach less than 1.7 picking motions to pick and transfer exactly three objects, while the SOP would need 3. If the task is to pick and transfer four 1-inch cubes, on average, it will take this approach less than 2.6 picking motions to pick and transfer exactly four objects, while the SOP would need 4. For the small cosmetic jar (cylin_m_s), when asked to pick and transfer exactly three jars, it takes this approach, on average, 1.085 to 1.150 picking motions to pick and transfer exactly three jars, while the SOP would need 3. It shows because of the capacity of the short gripper. The best strategy is to pick either 2 or 3 objects at a time if the desired number k is over 3.

A trend can also be seen—when the density increases, the average picking trials decreases. This is because the low-density layouts are less likely to provide a decent number of clusters. The effect of the density on the success rates next is further studied.

Study on Density Effect: As shown in previous tables, the number of objects inside the picking bin may greatly affect the picking result and accuracy, especially when the target number is higher. Therefore, simulation experiments have been conducted to explore how different densities affect picking results. The study has been done on all 12 objects. The density effects are similar for all of them. So, here the results on cube_m_s are shown as an example in Table 6. When the target picking number is 2, there is no significant difference in OSR or ESR among different object densities, this is because AR is very high since finding a pose to pick 2 objects is easy. The lowest OSR and ESR are both 96.00%, and the highest OSR and ESR are both 97.50%. When the target number is 3 or 4, it can be seen that the AR strictly increases when the density increases, this causes OSR increases as well since ESR does not have a clear trend of changing for different densities. This is because when more objects are in the bin, there are more candidate clusters to select from.

TABLE 5
Picking result under different object density.

Target Picking Num

| Density | Result | 2 | 3 | 4 |
|---|---|---|---|---|
| 20 | AS | 100.00% | 77.00% | 10.50% |
| | ESR | 97.50% | 74.03% | 61.90% |
| | OSR | 97.50% | 57.00% | 6.50% |
| 25 | AS | 100.00% | 84.00% | 14.50% |
| | ESR | 97.00% | 67.86% | 68.97% |
| | OSR | 97.00% | 57.00% | 10.00% |
| 30 | AS | 100.00% | 90.50% | 21.50% |
| | ESR | 96.00% | 72.93% | 58.14% |
| | OSR | 96.00% | 66.00% | 12.50% |
| 35 | AR | 100.00% | 91.00% | 30.50% |
| | ESR | 97.00% | 71.98% | 67.21% |
| | OSR | 97.00% | 65.50% | 20.50% |
| 40 | AR | 100.00% | 90.50% | 32.50% |
| | ESR | 96.00% | 75.14% | 76.92% |
| | OSR | 96.00% | 68.00% | 25.00% |

Overall, since high density provides more clusters, the proposed approach is more likely to find a suitable cluster, especially for picking 3 and 4 objects. It doesn't affect picking two because clusters of two are common and a picking pose is easier to find compared to higher number picking. The ESR rate is not associated with the density because our MOP predictors have a consistent accuracy over different densities.

Ablation Study: The proposed approach could be simplified by eliminating the cluster ranking module and confidence threshold in searching for the picking pose. To demonstrate the benefit of including them, three baseline approaches are defined. The baseline #1 (B-1) does not contain the cluster ranking module but uses the good-enough confidence threshold for early stopping. The baseline #2 (B-2) has the cluster ranking module, but sets no confidence threshold, it returns the first found action that is predicted to pick k according to the MOP predictor. The baseline #3 (B-3) does not contain the cluster ranking module and exhaustively searches through all clusters.

Three ablation studies were performed in simulation on cube_m_s in five different densities with target picking number 3. The study results are shown in Table 5.6. They are separated by /. The first value represents the number of searched clusters before finding the action. The second value is OSR. The third value is ESR. All numbers are the average numbers of 200 random scenes for a given density. Different algorithms are tested on the same series of random scenes. The table shows five different density results and the average number of five different density results.

TABLE 6
Ablation Study Table.

| | Density | | | | | |
|---|---|---|---|---|---|---|
| | 20 | 25 | 30 | 35 | 40 | Average |
| Setting | Result (num of inspected clusters/OSR/ESR) | | | | | |
| *PA | 2.76/57.00%/ | 4.67/57.00%/ | 7.15/66.00%/ | 11.69/65.50%/ | 15.71/68.00%/ | 8.40/62.70%/ |
| | 74.03% | 67.86% | 72.93% | 71.98% | 71.58% | 71.68% |
| B-1 | 4.02/56.00%/ | 7.85/57.00%/ | 13.24/64.50%/ | 19.16/66.00%/ | 28.08/68.00%/ | 14.47/62.30%/ |
| | 72.73% | 67.86% | 71.27% | 72.53% | 71.58% | 71.19% |
| B-2 | 2.30/51.50%/ | 2.72/49.50%/ | 3.95/61.00%/ | 4.37/61.50%/ | 5.73/59.50%/ | 3.81/56.60%/ |
| | 66.88% | 58.93% | 67.40% | 67.58% | 62.63% | 64.68% |
| B-3 | 3.21/51.00%/ | 7.33/48.50%/ | 10.07/61.00%/ | 16.92/61.00%/ | 23.37/60.00%/ | 12.18/56.30%/ |
| | 66.23% | 57.74% | 67.40% | 67.03% | 63.16% | 64.31% |

When the density is 20, this approach takes 2.76 clusters on average to find an action to pick three cubes, which is 31.4% less than B-1 and 20.0% more than B-2. As for picking success rate, ESR for this approach is 57.00% for OSR and 74.03% for ESR, 5.50% and 7.15% higher compared to B-1, and 1.00% and 1.30% higher compared to B-1. B-3 performs the worst for both cluster searching efficiency and success rate. As the object density increases, the difference between this approach and algorithms without ranking becomes larger since the layout becomes much more complicated.

On average, for all five densities, our approach reduces 41.95% number of searched clusters compared to B-1, and 6.10% and 7.00% higher accuracy on OSR and ESR compared to B-2. To make a conclusion for the ablation study, this approach performs the best in success rate with sacrificing a bit more computation time compared to B-2, however as our algorithm processes each cluster quickly, each action generation for our approach usually takes less than 3-4 seconds and is tolerable. The cluster ranking module is a key part of the approach to increase searching efficiency without sacrificing anything.

This algorithm on average takes 8.40 clusters to search and achieves a 62.70% overall accuracy, which is a 41.95% save compared to no cluster ranking baseline and a 6.10% improvement compared to no confidence threshold.

Generalization Study: To evaluate if the trained object picking number estimation model can generalize to unseen size and shape objects, a series of experiments were designed and tested to measure the performance of our algorithm on different size and shape objects.

Table 7 shows the simulation result on different size objects unseen during the training stage. cube_s_s and cube_l_s are the smaller and larger versions of the original trained cube_m_s object.

The result shows that cube_s_s achieves relatively similar results in all three different target number picking experiments: 3.00% lower and 3.00% lower than cube_m_s in OSR and ESR when the target is 2, 9.50% higher and 0.27% higher than cube_m_s in OS and ES when the target number is 3, 2.00% higher and 8.93% higher than cube_m_s in OS and ES when the target number is 4.

When testing on cube_l_s, the target number 2 result is not worse than cube_m_s. However, the OSR decreases significantly in target 3 and 4 picking experiments. This is because cube_l_s is about 20% larger than cube_m_s and makes picking more objects harder. Meanwhile, larger object occupies more space and leaves fewer available picking actions.

The result for cylin_s_s and cylin_l_s is similar to the result cylin_m_s in target 2 picking. When the target number is 3, cylin_s_s is 2.00% lower than cylin_m_s in OSR and 4.00% lower than cylin_m_s in ESR. cylin_l_s is 31.00% lower than cylin_m_s in OSR and 21.99% lower than cylin_m_s in ESR.

This extensive study on different sizes from the trained objects shows that our model can generalize well to different-sized objects, especially smaller objects, due to more available picking actions in less crowded spaces.

TABLE 8
Hexagon Table.

| | | | Target |
|---|---|---|---|
| Setting | Obj Index | Result | 2 |
| Simulation | hexa_s_s | OSR | 62.50% |
| (200) | (20) | ESR | 62.50% |
| | hexa_m_s | OSR | 67.00% |
| | (20) | ESR | 67.00% |
| | hexa_l_s | OSR | 61.00% |
| | (20) | ESR | 61.00% |
| Real | hex_m_s | OSR | 63.75% |
| (80) | (15) | ESR | 65.38% |

This approach was also evaluated to an unseen shape, a hexagon, in both simulation and real testing. The shorter gripper MOP predictor has never seen a hexagon shape during the training stage. Therefore this testing can give us insight into the possibility this model can generalize to more complex shapes in future works. Table 8 shows the picking result of the hexagon in three different sizes in simulation and metal hexagonal nuts. The result shows hexa_m_s has the highest OSR and ESR in simulation when picking two objects, reaching 67.00% in both success rates.

In real-world testing, the hexagonal metal nuts have the same size as hexa_m_s. The result OSR reaches 63.75% and ESR reaches 65.38%. Therefore, the trained model and algorithm can partially generalize to a shape never seen before.

This algorithm also shows the trained model can generalize to different sizes of cubes and cylinders: 2.0 cm and 3.0 cm cubes achieved more than 90% overall accuracy when picking 2 objects. The result shows the model can generalize to both sizes, but the overall success rate for larger than original objects decreases due to more collision. The evaluation result also shows that hexagon can achieve 67.00% and 63.75% overall success rate for target #=2 picking in simulation and real. This success rate is lower than the original trained shape, but still better than SOP theoretical result.

What is claimed is:

1. A method for generating a picking plan for a robotic picking arm, the method comprising:
obtaining a user input, the user input comprising a desired picking characteristic;
processing sensor data indicative of a work environment containing a plurality of objects;
generating a graph based on the sensor data of the work environment;
identifying a plurality of connections on the graph based on a plurality of relative locations corresponding to each of the plurality of objects;
extracting a plurality of clusters from the plurality of connections;
determining a plurality of ranks corresponding to each of the plurality of clusters using a ranking algorithm;
generating the picking plan, where the picking plan comprises a plurality of grasping poses associated with each of the plurality of ranks; and
outputting the picking plan.

2. The method of claim 1, further comprising:
analyzing the plurality of clusters and detecting a collision cluster containing a collision pose; and
deleting the collision cluster from the plurality of clusters.

3. The method of claim 1, wherein the plurality of grasping poses comprises collision-free poses.

4. The method of claim 1, further comprising generating a confidence estimation using a trained neural network model.

5. The method of claim 1, wherein the plurality of grasping poses fit in an effective gripping area.

6. The method of claim 5, wherein generating the picking plan comprises performing a set of operations substantially in accordance with Algorithm 1.

7. The method of claim 1, wherein the ranking algorithm comprises calculating the plurality of ranks substantially in accordance with Algorithm 2.

8. The method of claim 1, wherein the picking plan further comprises a first plurality of coordinates corresponding to a location in the work environment; and a second plurality of coordinates corresponding to a location of the robotic picking arm.

9. The method of claim 1, wherein outputting the picking plan comprises:
matching the picking plan with the sensor data of the work environment to create a pair; and
storing the pair in a training dataset; and
training a neural network to generate picking plans that implement the desired picking characteristics for objects based on using sensor data as an input.

10. A system for picking objects, the system comprising:
a sensor;
a robotic device, the robotic device comprising a multi-axis arm and a set of paddles;
a processor electrically coupled to the sensor and the robotic device;
a memory in communication with the processor, wherein the processor is configured to execute instructions embodied in the memory to:
obtain a user input, the user input comprising a desired picking characteristic;
process an image of a work environment containing a plurality of objects;
generate a graph based on the image of the work environment;
identify a plurality of connections on the graph based on a plurality of relative locations corresponding to each of the plurality of objects;
extract a plurality of clusters from the plurality of connections;
determine a plurality of ranks corresponding to each of the plurality of clusters using a ranking algorithm;
generate a picking plan, wherein the picking plan comprises a plurality of grasping poses associated with each of the plurality of ranks; and
output the picking plan to move the robotic device.

11. The system of claim 10, wherein the sensor is a Red Green Blue Depth (RGBD) vision sensor.

12. The system of claim 10, wherein the sensor is positioned above the work environment.

13. The system of claim 10, wherein the picking plan further comprises a first plurality of coordinates corresponding to a location in the work environment; and a second plurality of coordinates corresponding to a location of the set of paddles.

14. The system of claim 10, wherein the plurality of objects comprises at least one of: a cube, a cylinder, a cuboid, or a hexagon.

15. The system of claim 10, wherein the plurality grasping poses comprises at least one of a griping pose to grip multiple objects.

16. A system for picking objects, the system comprising:
a sensor;
a robotic device, the robotic device comprising a multi-axis arm and a set of paddles;
a processor electrically coupled to the sensor and the robotic device;
a memory in communication with the processor, wherein the processor is configured to execute instructions embodied in the memory which cause the processor to:
determine a desired grasping characteristic;
receive an output of the sensor, and determine a grasping plan to achieve the desired grasping characteristic for a given workspace sensed by the sensor; and
send a plurality of movement instructions to a plurality of motors of the multi-axis arm, wherein the plurality of movement instructions cause the robotic device to pick a plurality of objects in one grasping motion using the paddles, the grasping motion being determined in accordance with the grasping plan and the plurality of objects being determined in accordance with the desired grasping characteristic.

17. The system of claim 16, wherein the plurality of objects are selected from a plurality of clusters.

18. The system of claim 16, wherein the desired grasping characteristic comprises at least one of: an orientation of the plurality of objects, a number of objects to be picked from the plurality of objects, one or more types of objects in the plurality of objects, a maximum number of grasping motions, a minimization of grasping motions for a given number of objects, or an identified importance of objects in the plurality of objects.

19. The system of claim 16 wherein the instructions further cause the processor to provide the output of the sensor as an input to a trained machine learning model, and to obtain the grasping plan as an output of the trained machine learning model; wherein the trained machine learning model was trained to generate grasping plans from sensor data using training data generated in accordance with the method of claim 9.
